(19) United States
(12) Patent Application Publication
(10) Pub. No.: US 2016/0203743 A1
(43) Pub. Date: Jul. 14, 2016

(54) GAME COACHING METHOD AND APPARATUS

(71) Applicant: CORAN J. CRIGLER, DULUTH, GA (US)

(72) Inventor: CORAN J. CRIGLER, DULUTH, GA (US)

(21) Appl. No.: 14/726,283

(22) Filed: May 29, 2015

Related U.S. Application Data
(60) Provisional application No. 62/125,004, filed on Jan. 12, 2015.

(51) Int. Cl. G09F 15/00

(52) U.S. Cl. CPC G09F 15/00

(57) ABSTRACT

A method of coaching a basketball game pregame or during the game halftime using a diagramming tool to facilitate learning and retention of game ideas with respect to plays and strategies. By holding the basketball diagramming tool against a writing surface, a person coaching a group of persons may produce one or more drawn full or half court images, which may be then be used to demonstrate plays, play adjustments and game strategies.

This application claims the benefit of priority of U.S. Provisional Application No. 62/125,004 filed Jan. 12, 2015, the entire disclosure of which is herein incorporated by reference.

### TECHNICAL FIELD

The present invention relates to a basketball coaching method using a portable, hand-held reversible diagramming tool to draw representations of game plays, play adjustments and game strategy before or during halftime at a basketball game, which is usable on a whiteboard or chalkboard surface only. The method and apparatus are especially designed for use in pre-game and intermission group coaching of players and coaching teams.

### BACKGROUND

Team sports that are played according to rules and which use defined playing surfaces often rely on the skill and intuitiveness of the players involved to determine the outcome of the game. The winning team is usually familiar with the strengths and weaknesses of its opponents, and prepares before games by studying plays and devising plays or adjustments to their rehearsed plays in anticipation of the other team's capabilities. During the game, it may also be necessary for the team to adjust its strategy towards the opposing team, and in this respect a team leader or coach may decide on changes to the game strategy and communicate such changes to the players. The methods for communicating plays have until now been rudimentary, and have largely involved sketching plays freehand on paper or a blackboard.

More recently, means for drawing replicas of the playing court for coaching purposes have included creating permanent models for individual one-to-one coaching use, or creating printable electronic court diagrams. For example, U.S. Pat. No. 4,468,862 (Barnhill) discloses a stencil for drawing the positions of the starting offensive player lineup on a football field. The stencil is used on paper for drawing offensive plays, e.g. for a playbook. The stencil is composed of elliptical apertures of a uniform size, each representing a player, in which the axes of the apertures are parallel with the major axis of the rectangle that is the stencil. The patent does not disclose a means for replicating the playing surface on which player positions may be identified. U.S. Pat. No. 5,626,478 (Gatlin) discloses a portable dry erase board in which one side is a plain whiteboard and the reverse side has an image of a game surface which is covered by a transparent layer upon which markings can be made. The board is meant for individual use and not for group instruction purposes, for example in settings where the plays are being drawn 10-20 feet away, and it does not provide for group coaching using multiple images of a playing surface. U.S. Pat. No. 5,263,866 (Campbell) discloses a game board that has a dry erase surface printed with a permanent representation of a basketball court. To the frame may be attached tokens that represent players as well as a holder for a writing implement such as a marker. This device is used to diagram a single stage of a play at any given time, and is not sized to create viewable displays for group instruction or sequential demonstration of play changes.

There remains a need, however, for a method and apparatus that provide for quick, easy drawing of multiple erasable or modifiable replicas of a full court or half court playing surface, and which are suitable for group instruction and to demonstrate a sequence of steps in a game play or adjustments to play during the halftime interval of a team-based court of field game.

### SUMMARY OF INVENTION

In one aspect, the present invention provides a method of coaching game plays and play adjustments in real time before or during the halftime interval of a court-based game, such as a game of basketball, before a group of players and/or coaching staff. The portable apparatus of the invention allows quick, consistent, scaled and accurate replication of court segments and mapping of plays across the replicated segments that are simultaneously viewable by the persons being instructed.

In another aspect, the invention provides a portable diagramming tool that incorporates linear and arced channels of varying length and position to define different regulation-style basketball courts, to scale.

Further, in another aspect, the invention comprises a portable diagramming tool that is modified to draw representations of the free throw zone in different methods, and which may be selected according to the nature of the instructional drawing surface, the available writing implements and the specificity of the drawing required for the play being illustrated.

In yet another aspect, the invention provides a portable and reversible diagramming tool that may be used to manually replicate half court and full court drawings.

### BRIEF DESCRIPTION OF DRAWINGS

FIG. 1 is a schematic representation of a method of coaching according to an embodiment of the invention, in which a diagramming tool of the invention is used to create images of a game surface.

FIG. 2 is a frontal plan view of a diagramming tool according to an embodiment of the invention.

FIG. 3 is a transverse sectional view through the horizontal apparatus of a diagramming tool according to the invention.

FIG. 4 is a frontal plan view of another embodiment of the invention in which the channel apertures representing the free throw line are shortened.

FIG. 5 is frontal plan view of the invention which includes a horizontally linear aperture representing a baseline.

FIG. 6 is a frontal plan view of a further embodiment of the invention comprising an arcuate slot opening representing the outer limits of the key or free throw circle.

FIG. 7 is a schematic drawing of instruction of a play adjustment according to a method of the invention.

### DESCRIPTION OF EMBODIMENTS

The coaching method described herein allows instruction that advantageously combines the auditory and visual capabilities of persons being instructed simultaneously on game plays and strategic adjustments to game plays in a group setting. According to this method, an instructor, such as a coach or team captain, uses a diagramming tool of the invention to manually trace a sequence of images of a court segment against a blackboard, dry erase board or other similar writing surface suitable for use in a classroom setting. The instructor then pictorially characterizes the movement of players against this sequence of court segment layouts to illustrate his or her spoken coaching instructions and information as well as explanations of the player movements on each court segment. In this manner, the coaching instructions or information can be simultaneously disseminated in visual and audible fashion to an assembly of players and/or coaching staff. By this means, changes can be communicated quickly and efficiently before a game or during a game, for example at breaks or halftime. As defined herein, a play is a strategic formation to help position players in optimal spots on the playing court or field to score the maximum number of points. A play adjustment, which is defined herein as a strategic adjustment to help counter defensive formations of the opposing team may be readily communicated as coaches observe changes in playing tactics or substitutions of players that might require a corresponding and evolutionary adjustment to the previously determined game strategy. The method thus facilitates improved comprehension and retention of game plays and strategies for players and coaching staff by utilizing visualized group instruction about the game plays, strategies, and positions of team players. The method additionally allows quick, efficient and concise communication of game changes.

The portable, reversible basketball game diagramming tool of the invention may be hand carried. In configuration, the tool is generally of a rectangular formation comprising aperture channels which may be traced within using a writing instrument when manually positioned against a black board, erase board, easel or other large instruction surface. The diagramming tool establishes a symbolized characterization, to scale, of the court layout in a regulation sized playing court. It should be noted that different sized courts and variations in layout are implemented for high school, college and professional play. For example, layouts from the International Basketball Federation (FIBA), the National Basketball Association (NBA) and the National College Athletic Association (NCAA) court layouts differ slightly in dimensions of the court features, such as the restricted arc radius, center circle diameter, key dimensions and distance of the free throw line from the point on the court below the backboard. However, the diagramming tool of the invention can be advantageously scaled to allow close replication of any such sized court. Additionally, since, the diagramming tool is reversible, it can be reversed about its longitudinal axis to provide a mirror image replica of the court segment selected to be drawn. Because it is also symmetrical about the longitudinal axis the tool can also be turned 180 degrees without reversing sides to create mirror images of half court or full court diagrams.

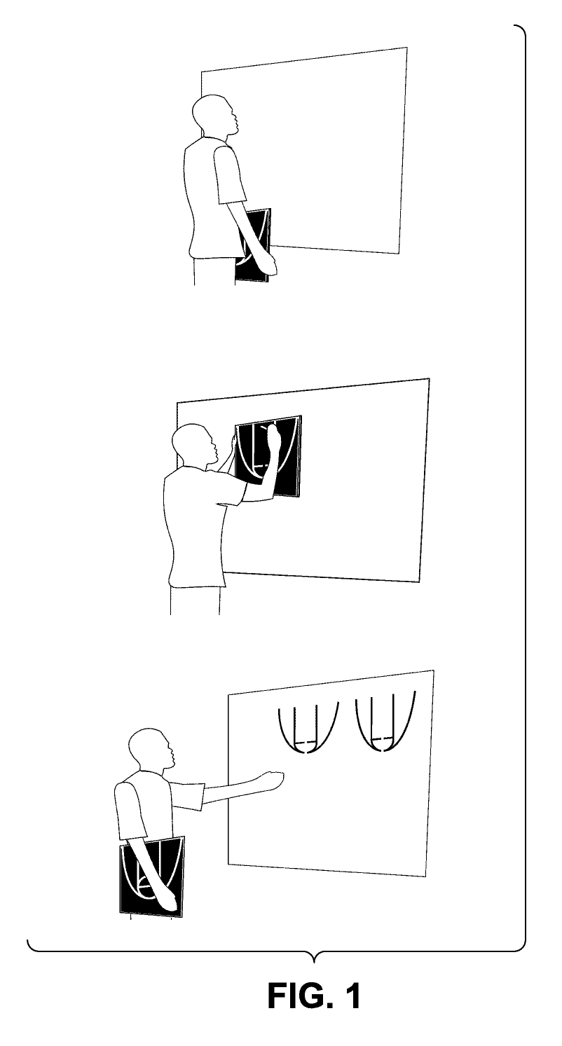

In a preferred embodiment of a method according to the invention, a reversible basketball diagramming tool is provided for use as a visual accompaniment to group instruction or coaching of a group of basketball players or coaching staff. As illustrated in FIG. 1, a person illustrating a play or play adjustment positions a diagramming tool according to the invention against a writing surface such as a blackboard or whiteboard, then traces a court outline using a tracing tool. Any suitable tracing or writing implement which has a tip which fits within the channels and is compatible with the writing surface to produce thick, visible lines, for example chalk or a dry erase marker, may be used to trace lines within the apertures located on the diagramming tool to form the outline of a half court segment. The user then draws at least one additional half court segment using the tool to create a sequence of court segments across which player positions may be drawn at different locations, along with lines, arrows or other indicia to indicate the positions and progressions of the play.

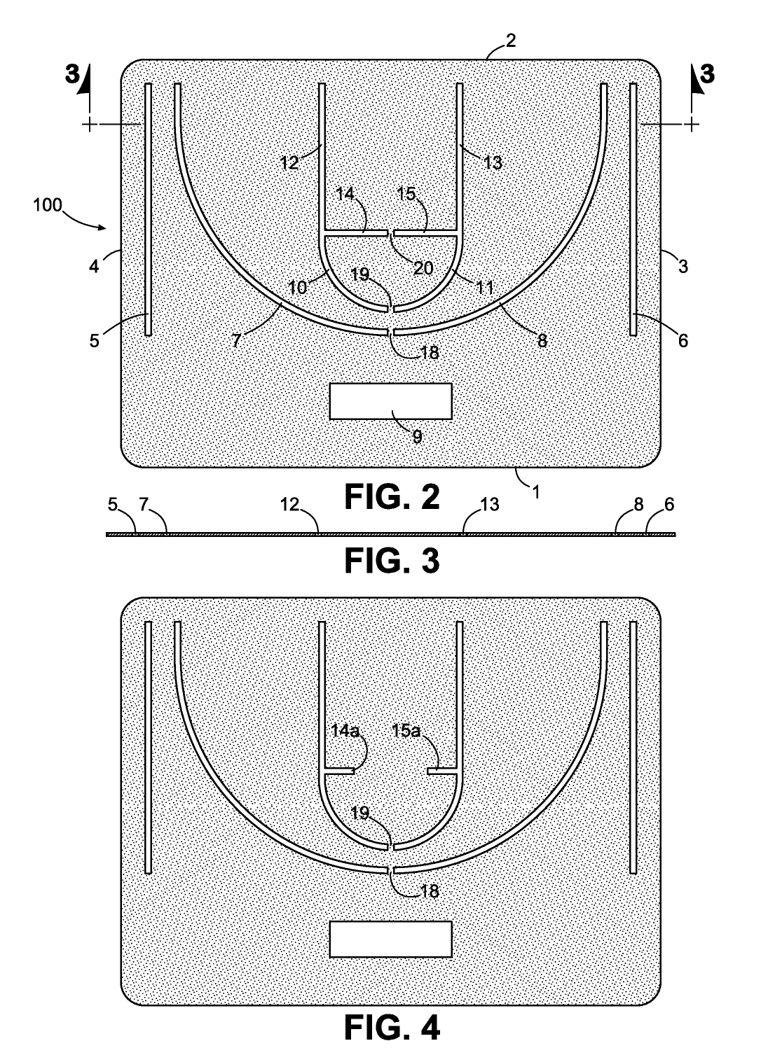

According to FIG. 2, an embodiment of a diagramming tool 100 according to the invention comprises a bottom edge 1, a top edge 2 which is substantially parallel in relation to the bottom edge 1, a right side edge 3 that is substantially parallel in position to a left side edge 4. Each of the side edges is perpendicular to the top and bottom edges, respectively. The tool is thus approximately rectangular in shape, providing a scaled representation of the dimensions of a basketball half court. Parallel to and spaced from the right and left side edges respectively are opposed linear channels 5, 6, each defining a sideline. A pair of symmetrically located arcs 7, 8 having a bridge element 18 between them define the two approximate halves of a three point line. All plays or formations are initiated from the three point line. This element is therefore important in the diagramming tool of the invention because it sets a point of reference for the spacing of the remainder of the court. On the actual playing surface, the three point line is the point of reference for the floor or court spacing for plays.

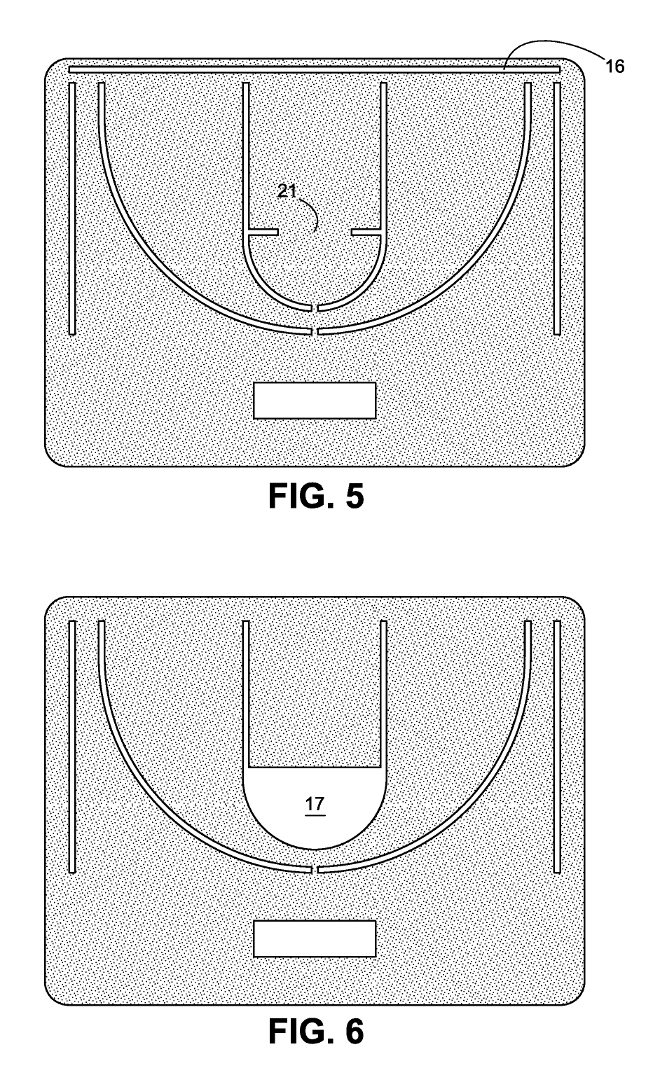

Lower edge 1 is used to trace a midcourt line in a method according to the invention. As further demonstrated in FIGS. 2, 3 and 4, parallel and oppositely positioned channels 5 and 6 define the court sidelines. Channels 12 and 13 for tracing free throw lane lines are oppositely positioned between the arcs 7 and 8 defining the three point line and the top edge 2. An inner terminus (with respect to the top and bottom edges) of each of the channels 12 and 13 is formed as arcs 10 and 11, respectively, which are separated by a bridge element 19. Channel extensions 14, 15 which are perpendicularly and contiguously associated with the channels 12 and 13 respectively, extend almost completely across the area defining the width of the free throw lane, separated by bridge element 20. Channel extensions 14 and 15 define the free throw line. The bridge element 20, as well as the bridge elements 18 and 19 support the rigidity of the diagramming tool by reducing the degree of flexion that might otherwise obtain from the bending of the tool about the relative weakness of the arced or horizontal channels.

FIG. 3 provides a cross sectional view showing the placement of the tracing channels. The thickness of the diagramming tool may range up to about ¾ inch thick, preferably from about ⅛ to about ¼ inch in thickness. The interposition of the channels across this thickness requires that the construction of the tool be of a sufficiently rigid material to render it durable and reusable and also capable of being positioned against the drawing surface to faithfully reproduce the court segments without shifting, gapping or twisting because of structural weakness. Suitable materials for construction of the apparatus may be selected from acrylic, polyvinyl chloride (PVC), polycarbonate, fiberboard, magnetic sheet materials, wood, and combinations thereof. The diagramming tool may be transparent, or it may be highly polished on one or both sides. Alternatively, one or both sides may be coated with a slip resistant coating or a tackifying material. Preferably, the surface can be wiped clean after use. The diagramming tools can be customized for various commercial applications, for example with team logos or colors, or promotional messaging such as sponsors' logos, images, slogans and trademark indicia.

While the apparatus of the invention is most significantly portable, lightweight and capable of being used manually without physical effort, other advantageous features of the invention include that the diagramming tools are stackable and thus easily shipped and stored. Typical dimensions vary between about 15 to 25 inches in width and from about 12 to about 20 inches in height. These dimensions allow the user to create a series of half court and full court images that are easily viewable by a group, for example in a classroom setting or about 10 to 20 feet away.

The diagramming tool of the invention may be temporarily mounted on a writing surface by using the advantageous features of the surface, for example by using thin magnetic strips on a metal dry erase board, or by using releasable adhesive strips, which may either be of the type having an extremely tacky surface to allow adherence to a whiteboard or chalkboard, or releasable adhesive strips which are stretched along an axis of flexibility to effect release. Any mount used should be sufficiently stable to prevent slippage while drawing, and should not significantly increase the depth of the channels for drawing, so that the tips of conventionally sized writing implements may be accommodated.

The bridge element between the perpendicular channel extensions defining the free throw line may be varied in width. In this way, the structural stability of the tool, depending on the choice of forming material, may be adjusted. Accordingly, as demonstrated in FIG. 5, a wider bridge element 21 may be incorporated into the construction. Additionally, as shown in FIG. 6, arcs 10 and 11 which define the free throw circle may be eliminated in favor of an open semi-circular slot 17, which may be more suitable for demonstrating player positions in that area of the court model. Such a modification of the tool provides a complete semicircle, which would not require further adjustment or free drawing in the drawing step. An additional modification that may be employed in certain embodiments of the invention is a linear aperture 16 located parallel to and positioned in close relation to the top edge 2, so as to define a midcourt line.

### EXAMPLE

### Play Adjustment for An Opponent Playing a 2-3 Defense

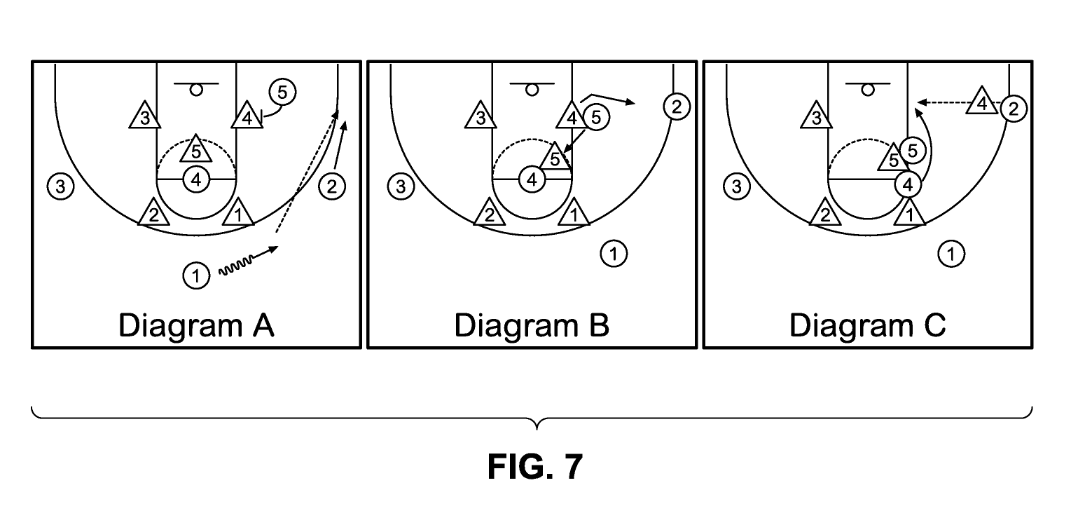

The method of the invention is used to illustrate court positions for players and coaching staff during coaching with regard to a strategic basketball play adjustment during halftime team meetings. According to the method of the invention, the diagramming tool of the invention is used to draw three identical half court images (Diagrams A, B and C) on a white board. The diagramming tool is propped against the whiteboard and lines defining the court are placed on the board to create the identical images. The method further includes including on each diagram symbols for offense and defense to indicate player locations based on what type of defense is being played by the opposing team. FIG. 7 is a diagram showing the strategy. Offensive positions are indicated by a circle symbol o and defensive positions are indicated by a triangle A. Each of the diagrams A, B, C shows movement of the offensive players. In Diagram A, O1 dribbles to the right to engage the outside top defender. O5 sets a screen on the outside low defender while O2 slides down to the corner. O1 passes to O2. O5 allows the defender to slip outside (Diagram B). Then, O5 screens the middle defender in the zone. O4 cuts around O5's screen for the pass from O2 and the layup (Diagram C). The entire sequence of plays may be quickly illustrated in a group setting using a whiteboard or chalkboard quickly and before an audience of multiple persons.

The method of the invention can be used to coach plays for a basketball game as well as for other court or field based games played by teams on standardized court or field layouts, and which may incorporate pre-determined, strategized plays or moves. Examples of these include but are not limited to volleyball, netball, tennis, football and soccer. In this respect, the term “court” may be interpreted to additionally encompass a playing field. It is noted that while the court or field in each game may be standardized, the layout is usually comprised of segments, threshold lines and circles representing various zones.

Numerous variations, adaptations and modifications of the invention will become readily apparent to those familiar with the instruction and coaching of other athletic sports, such as football, golf or other field and court games, and would be within the scope of the invention. It is apparent to those familiar with basketball court games, that the arcs, semicircles, and line aperture and the edge lines are designed as part of the reversible diagramming tool are in scaled down correlation of the regulations required of actual basketball court layouts, and thus the invention is not limited to specific scale sizes.

I claim:

1. A method of coaching game strategies or play adjustments before or during the halftime of a court based game by facilitating visual learning by team players or coaching staff, comprising the steps of:
a. determining whether an adjustment to a current or future game strategy is required during the halftime or before the end of the game;
b. assembling the team players or coaching staff in one location that allows for simultaneous common viewing of the first and second viewable displays; and
c. using a reversible diagramming tool to diagram at least one scaled half-court drawing on the surface of a teaching aid such as a blackboard, easel or dry erase board to form a first viewable display of the game strategy, wherein said reversible diagramming tool is a portable apparatus that comprises a handle slot, a bottom edge, a top edge parallel and oppositely placed to the first edge representing a baseline, two side edges oppositely placed and perpendicular to the top edge and the bottom edge; two parallel and oppositely placed channels in proximate relation to the side edges, defining sidelines; one or more curved channels defining a first semicircular arc between the top edge and the bottom edge; one or more curved channels defining a second semicircular arc between the first semicircular arc and the bottom edge, each in communication with the end of one of two parallel and oppositely positioned linear channels to define the second semicircular arc; and a first and second channel representing a free throw line between the second semicircular channel and the bottom edge; and a linear channel parallel to each side edge; and wherein each channel of the reversible diagramming tool is sized to receive the writing tip of a writing tool;
d. using the reversible diagramming tool to diagram, in series, at least one additional and identical half-court on the surface of the teaching aid, thereby forming one or more second viewable displays, wherein said additional displays are modified to define a step of a game play that is different from that represented in the first display; and
e. presenting the new play or play adjustment to the assembled team players or coaching staff using the first and one or more second viewable displays.

2. The method of claim 1 wherein the game is a basketball game.

3. The method of claim 1 further comprising using the diagramming tool to draw an additional symmetrically reversed half-court diagram that is opposedly connected to the first half court diagram via the baseline.

4. The method of claim 1 further comprising using the diagramming tool to draw at least one additional, symmetrically reversed half-court diagram that is opposedly connected to the at least one additional half court diagram via the baseline.

5. A rigid, portable, hand-held, reversible diagramming tool for quickly drawing scaled images of a basketball half court or full court comprising: a bottom edge positioned in parallel relationship to a top edge, a right edge in parallel relationship to a left edge, a set of linear channel apertures representing court side lines; one or more first curved channels together with a first interposed bridge element defining a first semicircular arc between the top edge and the bottom edge; a pair of parallel and oppositely positioned channels in communication, each having in communication therewith an inwardly extending and perpendicularly positioned channel extension representing a free throw line in communication with one or more second arced channels defining a second semicircular arc between the first semicircular arc and the top edge; and a handle slot for carrying and positioning the tool; wherein the tool is configured to provide a representation of a basketball half court.

6. The diagramming tool of claim 5 wherein, the second semicircular arc is formed by a pair of second arced channels having between them a second interposed bridge element.

7. The diagramming tool of claim 5 wherein the second interposed bridge element is varied in width.

8. The diagramming tool of claim 5 further comprising a linear aperture located parallel to and positioned proximate to the top edge, defining a midcourt line.

9. The diagramming tool of claim 5 having reversible symmetry for use on both sides to create reversible images of a basketball court.

10. The diagramming tool of claim 5 further comprising mounting means such as magnetic strips or releasable adhesive strips.
